(19) United States
(12) Patent Application Publication
(10) Pub. No.: US 2026/0073463 A1
(43) Pub. Date: Mar. 12, 2026

(54) INFORMATION PROCESSING METHOD

(71) Applicant: Toyota Jidosha Kabushiki Kaisha, Toyota-shi (JP)

(72) Inventor: Hirofumi MORISHITA, Toyota-Shi (JP)

(73) Assignee: Toyota Jidosha Kabushiki Kaisha, Toyota-shi (JP)

(21) Appl. No.: 19/226,323

(22) Filed: Jun. 3, 2025

(30) Foreign Application Priority Data
Sep. 10, 2024 (JP) 2024-156939

(51) Int. Cl. G06Q 50/18; G06Q 30/0203

(52) U.S. Cl. CPC G06Q 50/188; G06Q 30/0203

(57) ABSTRACT

An information processing method, comprising: inputting voice data related to an opportunity to a learned learning model; further estimating a stage of the opportunity in the estimating step; estimating a topic or a question to be next thrown to a customer according to the estimated stage of the opportunity; and displaying the estimated result on a terminal device.

### CROSS-REFERENCE TO RELATED APPLICATION

This application claims priority to Japanese Patent Application No. 2024-156939 filed on Sep. 10, 2024. The disclosure of the above-identified application, including the specification, drawings, and claims, is incorporated by reference herein in its entirety.

### BACKGROUND

### 1. Technical Field

The present disclosure relates to an information processing method.

### 2. Description of Related Art

Japanese Unexamined Patent Application Publication No. 2019-28910 (JP 2019-28910 A) discloses a system for analyzing details of a business negotiation.

### SUMMARY

When an inexperienced staff member alone negotiates with a customer, he/she needs support to follow the negotiation method of skilled staff members in order to smoothly proceed with the business negotiation. JP 2019-28910 A does not mention such support.

It is an object of the present disclosure to support an inexperienced staff member in a business negotiation using machine learning.

An information processing method according to one embodiment of the present disclosure includes:
inputting voice data related to a business negotiation into a trained learning model;
presuming a phase of the business negotiation;
presuming a topic or a question to be posed next for a customer based on the presumed phase of the business negotiation; and
displaying a result of the presuming on a terminal device.

According to the present disclosure, it is possible to support the inexperienced staff member in the business negotiation using the machine learning.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a configuration of a system according to an embodiment of the present disclosure; and

FIG. 2 is a flowchart illustrating an example operation of a system according to an embodiment of the present disclosure.

### DETAILED DESCRIPTION OF EMBODIMENTS

Hereinafter, an embodiment of the present disclosure will be described below with reference to the drawings. In the drawings, parts having the same configuration or function are denoted by the same reference numerals. In the description of one embodiment of the present disclosure, duplicate descriptions of the same parts may be omitted or simplified as appropriate.

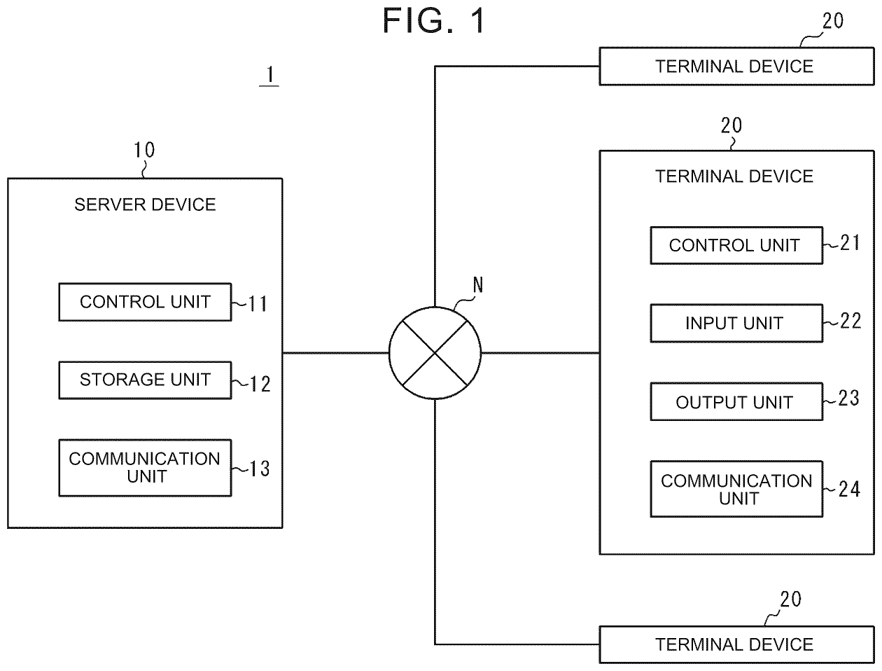

Referring to FIG. 1, a configuration of a system 1 according to an embodiment of the present disclosure will be described.

The system 1 includes a server device 10 capable of communicating with each other via a network N, and one or more terminal devices 20.

The server device 10 includes a control unit 11, a storage unit 12, and a communication unit 13.

The control unit 11 includes one or more processors, one or more dedicated circuits, or a combination thereof, and executes predetermined processing. A processor may be a general-purpose processor such as CPU (Central Processing Unit) or GPU (Graphics Processing Unit), or a special-purpose processor specialized for a particular process. The dedicated circuit is, for example, a field-programmable gate array (FPGA) or an application-specific integrated circuit (ASIC). The control unit 11 executes various processes related to the operation of the server device 10 and controls each unit of the server device 10.

The storage unit 12 includes at least one semiconductor memory, at least one magnetic memory, at least one optical memory, or a combination of at least two types thereof. The storage unit 12 stores data used for the operation of the server device 10 and data obtained by the operation of the server device 10. In an embodiment of the present disclosure, the storage unit 12 stores a learning model trained by history information of a topic or a question cast by a skilled staff member to a customer.

The communication unit 13 includes at least one communication interface. The communication unit 13 receives data used for the operation of the server device 10 and transmits data obtained by the operation of the server device 10. In an embodiment of the present disclosure, the communication unit 13 communicates with the terminal device 20.

The terminal device 20 includes a control unit 21, an input unit 22, an output unit 23, and a communication unit 24.

The control unit 21 includes one or more processors, one or more dedicated circuits, or a combination thereof. A processor may be a general-purpose processor such as CPU (Central Processing Unit) or GPU (Graphics Processing Unit), or a special-purpose processor specialized for a particular process. The dedicated circuit is, for example, a field-programmable gate array (FPGA) or an application-specific integrated circuit (ASIC). The control unit 21 executes various processes related to the operation of the terminal device 20 and controls each unit of the terminal device 20.

The input unit 22 includes one or more input interfaces. The input interface is, for example, a physical key, a capacitive key, a pointing device, a touch screen integrated with a display, or a microphone that receives voice input. The input unit 22 receives an operation of inputting information used for the operation of the terminal device 20.

The output unit 23 includes one or more output interfaces. The output interface is, for example, a connection interface with an external or built-in display or an external output device that outputs information as an image or video. The display is, for example, a liquid crystal display (LCD) or an organic electro luminescence (EL) display. The output unit 23 outputs information obtained by the operation of the terminal device 20.

The communication unit 24 includes at least one communication interface. The communication unit 24 receives data used for the operation of the terminal device 20 and transmits data obtained by the operation of the terminal device 20. In an embodiment of the present disclosure, the communication unit 24 communicates with the server device 10.

Network N includes the Internet, at least one LAN (Local Area Network), at least one WAN (Wide Area Network), at least one MAN (Metropolitan Area Network), or any combination thereof.

Hereinafter, a method of generating a learning model according to an embodiment of the present disclosure will be described.

The control unit 21 of the terminal device 20 receives the input of the learning data from the skilled staff via the input unit 22. The learning data includes historical information of topics or questions that the skilled staff has thrown to the customer. The learning data may further include stage information of the opportunity. The stage information of the business negotiation may be, for example, five stages of “approach”, “need hearing”, “vehicle type proposal”, “price negotiation”, and “contract establishment”. The stage information of the opportunity may include annotations about the opportunity entered by the skilled staff. The stage information of the opportunity may be associated with the history information.

The control unit 11 of the server device 10 receives learning data from the terminal device 20 via the communication unit 13, performs machine learning, and generates a learning model. The algorithm for machine learning is not particularly limited. The control unit 11 of the server device 10 stores the generated learning model in the storage unit 12.

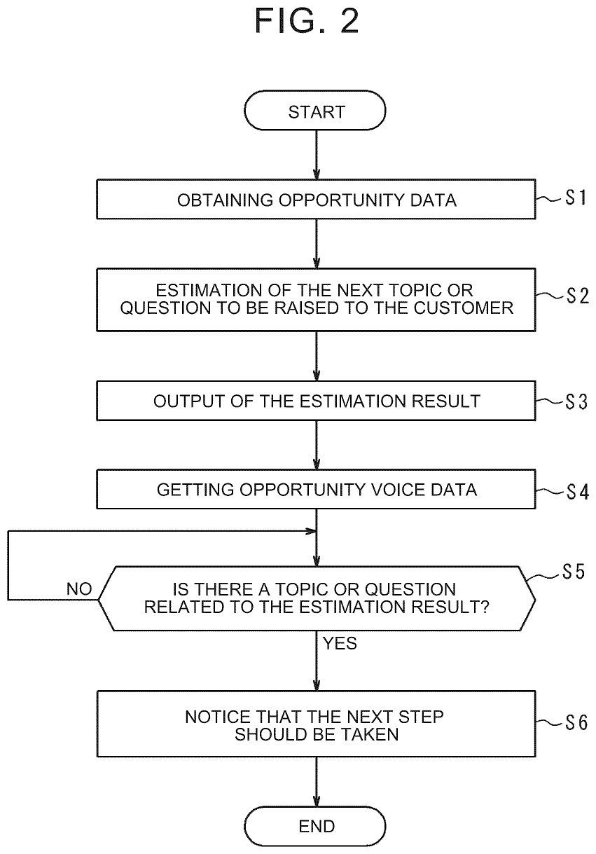

Hereinafter, a method of business negotiation support using the system 1 according to an embodiment of the present disclosure will be described with reference to FIG. 2.

In S1, the control unit 21 of the terminal device 20 acquires, via the input unit 22, opportunity data that is data related to an opportunity to be supported. The data to be acquired may be voice data, but is not limited thereto. For example, it may be character data. The control unit 21 of the terminal device 20 transmits the acquired negotiation data to the server device 10 via the communication unit 24.

In S2, the control unit 11 of the server device 10 calls the learning model from the storage unit 12, inputs the business opportunity data received from the terminal device 20 into the learning model, and estimates a topic or a question to be thrown next to the customer. The control unit 11 of the server device 10 transmits, via the communication unit 13, a topic or a question to be thrown next to the customer as the estimation result to the terminal device 20.

The control unit 11 of the server device 10 may estimate the stage of the ongoing business opportunity by inputting the business opportunity data received from the terminal device 20 into the learning model. In this case, the control unit 11 of the server device 10 may estimate a topic or a question to be thrown next to the customer according to the estimated stage of the business negotiation.

In S3, the control unit 21 of the terminal device 20 outputs the estimation result received from the server device 10 to the output unit 23. The output format is not particularly limited, but an estimation result may be output to the display in a checklist format, for example.

In S4, the control unit 21 of the terminal device 20 acquires the audio data of the business negotiation via the input unit 22. The control unit 21 of the terminal device 20 transmits the acquired voice data of the opportunity to the server device 10 via the communication unit 24.

In S5, the control unit 11 of the server device 10 determines whether a subject or a question related to the estimation result is made when the audio data is received from the terminal device 20. When it is determined that the subject or the question related to the estimation is made (S5: Yes), the control unit 11 of the server device 10 performs S6 process. When it is determined that the subject or the question related to the estimation is not performed (S5: No), the control unit 11 of the server device 10 waits until the subsequent voice data is received from the terminal device 20, and when the voice data is received, S5 process is performed again.

In S6, the control unit 11 of the server device 10 controls the terminal device 20 via the communication unit 13 so as to notify that the process should proceed to the subsequent stage of the business negotiation.

By adopting the above-described method, inexperienced staff can follow the business negotiation process of the skilled staff, and can improve the efficiency of the business negotiation.

Hereinafter, a modification of the present disclosure will be described.

In a modification example according to the embodiment of the present disclosure, the learning data on which the learning model is generated further includes the skilled staff information that is information about the attribute of the skilled staff to be input. The expert staff information may include at least one of an age of the expert staff, a region in charge, a favorite vehicle type, expertise, or type information. The type information is information indicating one or more categories selected according to the tendency of the staff from a plurality of categories set in advance. Examples of the type information include, but are not limited to, “customer: family group”, “customer: 30's”, “excellent vehicle type: luxury vehicle”, and the like. The type information may be determined based on at least one of a customer characteristic, a staff characteristic, or an opportunity area. The customer characteristics may include information regarding at least one of an age group, a family composition, a hobby, or a desired vehicle type of the customer. The staff characteristics may include information regarding at least one of the age of the skilled staff, the age of experience, the type of vehicle with a sales track record, or the level of expertise.

Further, in the modification of the present disclosure, the customer characteristics of the customer of the business opportunity to be supported may be included in the business opportunity data.

By adopting such a configuration, it is possible to estimate more appropriate topics or questions based on the situation of the opportunity, and thus it is possible to improve the efficiency of the opportunity.

The present disclosure is not limited to the embodiment described above. For example, blocks shown in the block diagram may be integrated, or a block may be divided. Instead of executing the steps shown in the flowcharts in chronological order according to the description, the steps may be executed in parallel or in a different order, depending on the processing capacities of the devices that execute the steps, or as necessary. Other changes may be made without departing from the scope of the present disclosure.

For example, in one embodiment of the present disclosure, the server device 10 determines whether the subject or the question related to the estimation result has been made, but the terminal device 20 may make this determination. In this case, the control unit 21 of the terminal device 20 may output, to the output unit 23, a notification indicating that the process should proceed to the next stage of the business negotiation.

What is claimed is:

1. An information processing method comprising:
inputting voice data related to a business negotiation into a trained learning model;
presuming a phase of the business negotiation;
presuming a topic or a question to be posed next for a customer based on the presumed phase of the business negotiation; and
displaying a result of the presuming on a terminal device.

2. The information processing method according to claim 1, wherein:
the learning model is trained using history information on topics or questions posed for customers by skilled staff members;
the history information is associated with phase information of the business negotiation; and
the phase information of the business negotiation includes annotations input by the skilled staff members.

3. The information processing method according to claim 2, wherein:
the learning model is further trained using skilled staff information on attributes of the skilled staff members;
the skilled staff information includes at least one of ages, areas in charge, specialty vehicle types, expertise, or type information for the skilled staff members;
the type information is determined based on at least one of customer characteristics, staff characteristics, or business negotiation areas;
the customer characteristics include information on at least one of age groups, family structures, hobbies, or desired vehicle types for customers; and
the staff characteristics include information on at least one of the ages, years of experience, vehicle types in sales records, or expertise levels for the skilled staff members.

4. The information processing method according to claim 1, further comprising displaying the result of the presuming on the terminal device in a checklist format.

5. The information processing method according to claim 1, further comprising:
determining whether the topic or the question related to the result of the presuming has been posed based on the voice data; and
notifying the terminal device to proceed to a next phase of the business negotiation when determination is made that the topic or the question related to the result of the presuming has been posed.
